(19) United States
(12) Patent Application Publication
(10) Pub. No.: US 2017/0356506 A1
(43) Pub. Date: Dec. 14, 2017

(54) DRIVING FORCE TRANSMISSION MECHANISM

(71) Applicant: NTN CORPORATION, Osaka (JP)

(72) Inventor: Seiichi TAKADA, Mie (JP)

(73) Assignee: NTN CORPORATION, Osaka (JP)

(21) Appl. No.: 15/524,825

(22) PCT Filed: Nov. 12, 2015
(86) PCT No.: PCT/JP2015/081851

§ 371 Date: May 5, 2017

(30) Foreign Application Priority Data
Nov. 17, 2014 (JP) 2014-232627
Feb. 4, 2015 (JP) 2015-020377
Jul. 8, 2015 (JP) 2015-136763

(51) Int. Cl. F16D 41/08; F16D 3/06; F16D 1/112; F16H 35/18; F16D 1/096; F16D 41/067; F16H 1/16; F16H 1/14; B25J 17/02; F16H 1/28; F16H 37/08

(52) U.S. Cl. CPC F16D 41/08; F16D 1/096; F16D 3/06; F16D 1/112; F16H 35/18; F16D 41/067; F16H 1/14; B25J 17/0291; F16H 1/2845; F16H 37/082; F16H 1/16

(57) ABSTRACT

A driving force transmission mechanism includes a worm gear unit as a brake disposed between a driving motor and an electrically driven input gear, and is configured such that when a driving force is applied from the driving motor to the electrically driven input gear through the worm gear unit, an outer ring which rotates together with the electrically driven input gear becomes locked to an inner ring through rollers so that the driving force is transmitted to an output gear, which rotates together with the inner ring, and when a driving force is applied to a manually driven input shaft, the outer ring and the inner ring are unlocked from each other by an unlocking piece which rotates together with the manually driven input shaft, and thereafter, the driving force is transmitted to the inner ring and the output shaft.

### TECHNICAL FIELD

The present invention relates to a driving force transmission mechanism including two input lines, one output line, and a brake.

### BACKGROUND ART

In a device that actuates a driven member under the driving force from a motor, when the driving motor is stopped to stop the driven member, or if the driving motor untimely stops due e.g., to power outage, the driven member could change its position (attitude) under an external force such as gravity, thus causing various kinds of trouble. This problem is avoidable by mounting a brake configured to hold the position of the driven member when the driving motor stops (such a brake is hereinafter simply referred to as the “brake”), in the driving unit (including the driving motor and the reduction gear) of the device. Such a brake is mounted in a driving unit of many conventional industrial robots.

Such brakes are typically non-excitation electromagnetic brakes. Ordinary non-excitation electromagnetic brakes include a brake plate provided in the drive line between the driving motor and the driven member, a friction plate pressed against the brake plate by a spring, and an electromagnet configured to move the friction plate away from the brake plate when the driving motor is energized, and are configured such that while the motor is in operation (energized), the friction plate is separated from the brake plate by compressing the spring with the electromagnet, and when the motor is stopped (de-energized), the friction plate is pressed against the brake plate under the elastic force of the spring to restrict the rotation of the brake plate, thereby retaining the position of the driven member.

While a brake of this type is capable of keeping the position of the driven member while the motor is at a stop (i.e., not energized), this brake also makes it impossible to move the driven member manually while the motor is at a stop, thus making it difficult to perform e.g., maintenance with the device de-energized.

To avoid this problem, the below-identified Patent document 1 proposes to provide a nut portion at the end of the input shaft of a reduction gear joined to the rotary shaft of the driving motor such that by rotating the input shaft of the reduction gear by manually operating a rotary jig fitted to the nut portion, the position of the driven member, which is joined to the output shaft of the reduction gear, can be changed. Since this device has, as described above, two input lines (electric input line and manual input line), and one output line, even when the electric input line (first input line) is at a stop and the brake is applied, it is possible to move the driven member from the manual input line (second input line) for e.g., maintenance.

### PRIOR ART DOCUMENT(S)

### Patent Document(s)

Patent document 1: JP Patent Publication 6-285785A

### SUMMARY OF THE INVENTION

### Object of the Invention

In a driving force transmission mechanism including two input lines and one output line, when an attempt is made to move the driven member from the second input line with the first input line at a stop and the brake being applied, it is necessary to simultaneously rotate the shafts of the reduction gear, the driven member, and the rotary shafts of the driving motor, against the braking force of the brake. Thus, if the braking force of the brake is set to a high value, or a large driving motor is used, according to e.g., the weight of the driven member, a large force is required to drive the driven member from the second input line. This increases the workload of e.g., maintenance.

An object of the present invention is to provide a driving force transmission mechanism including two input lines, one output line, and a brake, and configured such that the driving force applied to either of the two input lines can be transmitted to the output line without interfering with the brake.

### Means for Achieving the Object

In order to achieve this object, the present invention provides a driving force transmission mechanism comprising a first input member, a second input member, an output member, and an input switching clutch coupled to the first input member, the second input member, and the output member, and configured to selectively transmit either one of first and second driving forces for rotationally driving the first input member and the second input member, respectively, to the output member, wherein the driving force transmission mechanism further includes a reverse input blocking unit mounted in an input side of the first input member, and configured to allow transmission of the first driving force, which is applied from a driving source, to the first input member, and to lock up when reverse input is applied to the first input member through the input switching clutch, thereby keeping the first input member stationary, wherein the input switching clutch includes: an outer ring configured to rotate together with the first input member; an inner ring provided radially inwardly of the outer ring, and configured to rotate about a rotation axis of the second input member together with the output shaft; and a plurality of rollers disposed between the outer ring and the inner ring, wherein the input switching clutch is configured such that when the first driving force is applied to the first input member through the reverse input blocking unit, the outer ring becomes locked to the inner ring through the rollers so that the first driving force is transmitted to the inner ring and the output member, and such that when the second driving force is applied to the second input member, and the second input member is rotated under the second driving force, the outer ring and the inner ring are unlocked from each other first, and thereafter, the second driving force is transmitted to the inner ring and the output member.

With this arrangement, while no driving force is being applied to either of the input line including the first input member and the input line including the second input member, although an external force, such as gravity, applied to the driven member, which is connected to the output member in the output line, is applied as reverse input to the first input member through the output member, the inner ring, the rollers, and the outer ring, since the reverse input blocking unit locks up, thereby stopping the movements of the first input member and the outer ring, the inner ring and the output member also stop, so that the position of the driven member remain unchanged. The driving force transmission mechanism is further configured such that when the first input member is rotationally driven, the reverse input blocking unit allows transmission of a driving force from the driving source to the first input member, and when the second input member is rotationally driven, the reverse input blocking unit stops the outer ring so that a driving force is smoothly transmitted from the second input member to the inner ring and the output member. Thus, this driving force transmission mechanism allows the driving force applied to either of the two input lines to be smoothly transmitted to the output line without interfering with the reverse input blocking unit, which serves as a brake when reverse input is applied.

In a more specific arrangement, the inner ring of the input switching clutch has an outer periphery including a plurality of circumferentially arranged cam surfaces, and the outer ring of the input switching clutch has a cylindrical inner peripheral surface, to define, between each of the cam surfaces and the cylindrical inner peripheral surface, a wedge-shape space which narrows gradually toward respective circumferential ends thereof, and in which two of the rollers and a spring are mounted such that the rollers are pushed by the spring into respective narrow circumferential end portions of the wedge-shaped space, wherein the input switching clutch further includes an unlocking piece having crossbars inserted on both circumferential sides of the respective wedge-shaped spaces, and coupled to the second input member such that rotation can be transmitted to the second input member, wherein a torque transmission means is provided between the second input member and the inner ring such that rotation of the second input member is transmitted to the inner ring through the torque transmission means with a slight angular delay, wherein the driving force transmission device is configured such that when the first driving force is applied to the first input member, the outer ring, which is configured to rotate together with the first input member, becomes locked to the inner ring through the rollers so that the first driving force is transmitted to the inner ring and the output member, and such that when the second driving force is applied to the second input member, one of the two rollers in each of the wedge-shaped spaces, which are opposed to each other in a rotational direction, is pushed toward a wide portion of the wedge-shaped space by corresponding ones of the crossbars of the unlocking piece, which is configured to rotate together with the second input member, against an elastic force of the spring in the wedge-shaped space so that the outer ring and the inner ring are unlocked from each other, and thereafter, the second driving force is transmitted to the inner ring and the output member through the torque transmission means.

If two driving forces are an electric driving force and a manual driving force, the first driving force is preferably the electric driving force, and the second driving force is the manual driving force. This is because, if the first driving force is a manual driving force, the manual driving force is used to rotate the reverse input blocking unit and the driving motor, which is now used as the driving source of the second input member. Thus, if the toque of the motor is large, the output member may not be driven by the manual force. Conversely, if the second driving force is the manual driving force, the input line including the first input member does not influence the manual driving force, so that it is possible to reduce the manual driving force to drive the second input member. Also, if the driving force transmission mechanism is formed with a hollow space extending through the entire driving force transmission mechanism so that e.g., a cable can be passed therethrough, and if the second driving force is an electric driving force, since the driving motor has to be arranged around the center axis of the entire driving force transmission mechanism, a special hollow motor has to be used as the driving motor. If, conversely, the second driving force is a manual driving force, an ordinary motor can be used as the driving motor, which is now used as the driving source of the first input member, so that it is possible to reduce the cost.

The reverse input blocking unit may be a worm gear unit including a worm gear configured such that the first driving force is applied to the worm gear, and a worm wheel meshing with the worm gear and coupled to the first input member such that rotation can be transmitted to the first input member, the reverse input blocking unit having a self-locking function. Alternatively, the reverse input blocking unit may include a pinion shaft configured such that the first driving force is applied to the pinion shaft, and a helical bevel gear meshing with the pinion shaft and coupled to the first input member such that rotation can be transmitted to the first input member, the reverse input blocking unit having a self-locking function.

Further alternatively, the reverse input blocking unit may be a reverse input blocking clutch including an input portion configured such that the first driving force is applied to the input portion, an output portion coupled to the first input member such that rotation can be transmitted to the first input member, a locking means configured to lock the output portion to a fixed member, an unlocking means configured to unlock the output portion from the fixed member when the input portion rotates, and means configured to transmit rotation of the input portion to the output portion with a slight angular delay when the output portion is unlocked from the fixed member. Still further alternatively, the reverse input blocking unit may include a wave generator configured such that the first driving force is applied to the wave generator, a circular spline fixed at a position radially outwardly of the wave generator, and a flex spline disposed between the wave generator and the circular spline, and coupled to the first input member such that rotation can be transmitted to the first input member, the reverse input blocking unit having a self-locking function.

The second input member may extend through the entire driving force transmission mechanism, and have two rotatably supported ends. With this arrangement, the driving force transmission mechanism can be easily mounted in various types of devices, and once mounted in a device, it shows high rigidity and is capable of stably transmitting driving forces.

By using a second input member which is detachable from the unlocking piece and the inner ring, it is possible to reduce the size and weight of the entire driving force transmission mechanism.

If the second driving force is a manual driving force, by providing, between the second input member and a manual input member configured to be operated under the manual driving force, a reduction unit configured to transmit, after reducing, the rotation of the manual input member to the second input member, it is possible to reduce the manual driving force.

Preferably, the reduction unit is a planetary gear unit comprising a sun gear configured such that the manual driving force is applied to the sun gear from the manual input member, an internal gear disposed radially outwardly of the sun gear, a plurality of planetary gears meshing with the sun gear and the internal gear, and a carrier supporting the planetary gears such that each of the planetary gears is rotatable about an axis of the planetary gear, and coupled to the second input member such that rotation can be transmitted to the second input member, and the internal gear is integral with the first input member. With this arrangement, while the first input member is stationary, the internal gear also remains stationary, so that by operating the manual input member, its rotation can be transmitted to the second input member after being reduced in speed by the planetary gear unit. When the first input member is rotationally driven and its driving force is transmitted to the output member, the rotation of the first input member is transmitted through the rollers, which are provided in the driving force transmission path, the unlocking piece and the second input member to the carrier such that the carrier rotates at the same number of revolutions as the internal gear, which is integral with the first input member. As a result, the planetary gears orbit the sun gear without rotating about their own axes, and thus, as though the planetary gears, the internal gear, and the sun gear were an integral body, so that the planetary gear unit does not increase the rotation of the first input member when it is transmitted to the sun gear and the manual input member. That is, the manual input member is rotated at a relatively low speed.

If the first driving force is an electric driving force, by providing the driving motor as the source of the electric driving force separately from a rotation detector for controlling the driving motor, it is possible to reduce the size of the entire driving force transmission mechanism. In this case, for higher rotation detection accuracy too, the rotation detector is preferably arranged so as to be coaxial with the driving motor.

When a rotation detector is used for detecting the number of revolutions of the output member, such a rotation detector is preferably provided inside of a fixed cover member covering the output member from radially outside of the output member. With this arrangement, the rotation detector is protected against foreign matter. By forming the cover member from metal, the rotation detector can be protected against electromagnetic noise too, so that the number of revolutions of the output member can be detected with high accuracy, and the driven member connected to the output member can be positioned with high accuracy.

The present invention is particularly effectively applicable to a driving force transmission mechanism mounted in a joint driving unit of a robot.

### Advantages of the Invention

Since, as described above, the driving force transmission mechanism according to the present invention includes two input lines, one output line, and a brake in the form of a reverse input blocking mechanism, and configured such that a driving force applied to the input line including the first input member is transmitted to the output member through the reverse input blocking unit, and a driving force applied to the input line including the second input member is transmitted to the output line without interfering with the reverse input blocking unit, while no driving force is being applied to either of the input lines, it is possible to keep the position of the driven member coupled to the output member unchanged. Also, no large force is required to move the driven member from the second input member with the first input member stationary for e.g. maintenance, so that the efficiency of maintenance improves.

### BRIEF DESCRIPTION OF THE DRAWINGS

FIG. 1 is a vertical sectional front view of a driving force transmission mechanism of a first embodiment.

FIG. 2 is a sectional view taken along line II-II of FIG. 1.

FIG. 3A shows an operational state of the driving force transmission mechanism of FIG. 1 when manual input is applied.

FIG. 3B shows an operational state of the driving force transmission mechanism of FIG. 1 when manual input is applied.

FIG. 4 is a vertical sectional front view of a driving force transmission mechanism of a second embodiment.

FIG. 5 is a sectional view taken along line V-V of FIG. 4.

FIG. 6 is a vertical sectional front view of a driving force transmission mechanism of a third embodiment.

FIG. 7 is a left-hand side view of an upper portion of the driving force transmission mechanism of FIG. 6.

FIG. 8 is a vertical sectional front view of a driving force transmission mechanism of a fourth embodiment.

FIG. 9 is a sectional view taken along line IX-IX of FIG. 8.

FIG. 10 is a vertical sectional front view of a driving force transmission mechanism of a fifth embodiment.

FIG. 11 is a sectional view taken along line XI-XI of FIG. 10.

FIG. 12 shows a manual input jig of FIG. 10, as seen from the right-hand side of FIG. 10.

FIG. 13 shows how the manual input jig of FIG. 10 is fitted to the driving force transmission mechanism of FIG. 10.

FIG. 14 is a vertical sectional front view of a driving force transmission mechanism of a sixth embodiment.

FIG. 15 is a sectional view taken along line XV-XV of FIG. 14.

FIG. 16 is a sectional view taken along line XVI-XVI of FIG. 14.

FIG. 17 is a vertical sectional front view of a driving force transmission mechanism of a seventh embodiment.

FIG. 18 is a right-hand side view of FIG. 17.

FIG. 19 is a vertical sectional front view of a driving force transmission mechanism of an eighth embodiment.

### BEST MODE FOR EMBODYING THE INVENTION

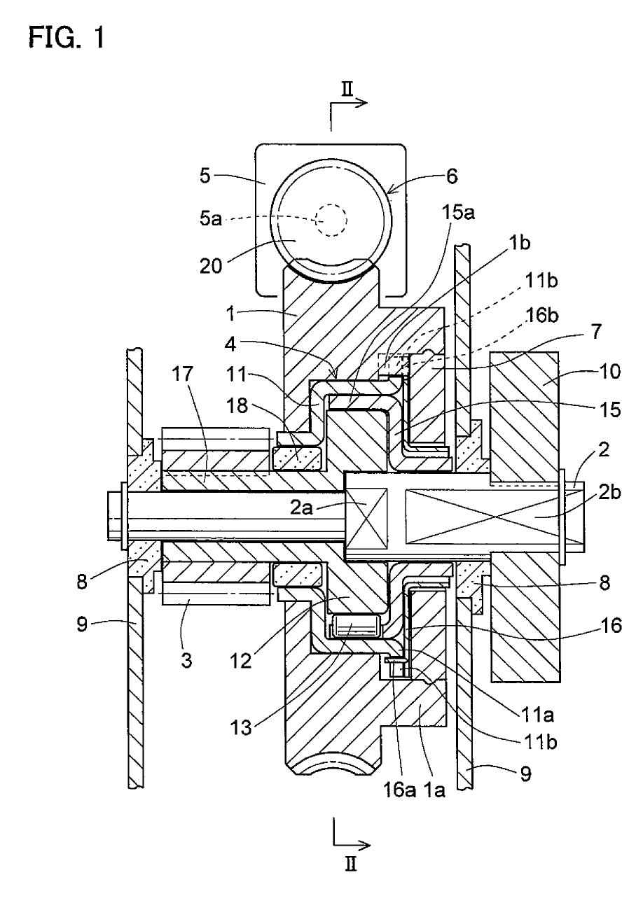

Now referring to the drawings, the embodiments of the present invention are described. FIGS. 1-3B show a driving force transmission mechanism of the first embodiment, which is mounted in a joint driving unit of an industrial robot such that the driven member of the joint driving unit can be driven both electrically and manually by the driving force transmission mechanism. As shown in FIG. 1, the driving force transmission mechanism is basically composed of: an electrically driven input gear (first input member) 1 rotationally driven by electric input; a manually driven input shaft (second input member) 2 rotationally driven by manual input; an output gear (output member) 3 meshing with a gear on the driven member side (now shown); an input switching clutch 4 coupled to the electrically driven input gear 1, the manually driven input shaft 2, and the output gear 3, and configured to selectively transmit either one of the electric input and the manual input to the output gear 3; a driving motor 5 as a driving source of the electrically driven input gear 1; and a worm gear unit 6 disposed between the driving motor 5 and the electrically driven input gear 1, as a reverse input blocking unit.

The electrically driven input gear 1 is a helical gear (worm wheel) of the worm gear unit 6 as will be de described below. The electrically driven input gear 1 includes a cylindrical portion 1a at one axial end thereof. The input switching clutch 4 is fitted into the electrically driven input gear 1 through an opening of cylindrical portion la. With the input switching clutch 4 fitted in the electrically driven input gear 1, the opening of the cylindrical portions 1a is closed by a lid 7.

The manually driven input shaft 2 has a large-diameter portion at the one end thereof; extends through the entire driving force transmission mechanism (i.e., through the input switching clutch 4 and the output gear 3); and are supported at both end portions thereof by fixed wall members 9 through sintered oil-containing bearings 8. The large-diameter portion of the manually driven input shaft 2 has a portion protruding beyond the corresponding wall member 9 and having an outer periphery on which is fixedly fitted a manual input member 10 which can be directly manually operated. The large-diameter portion of the manually driven input shaft 2 has two flat surfaced sections 2a and 2b axially displaced from each other, and each having two opposite flat surfaces.

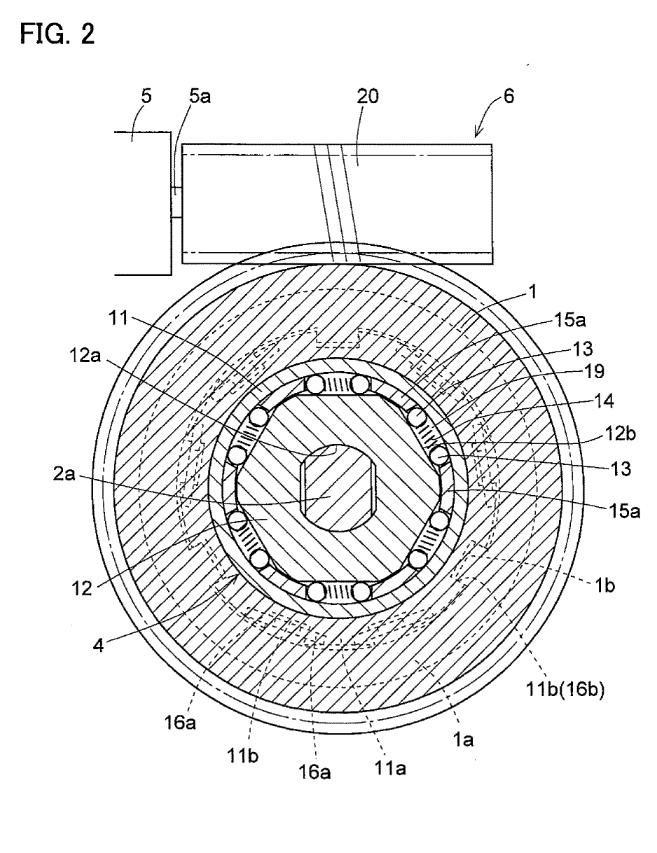

As shown in FIGS. 1 and 2, the input switching clutch 4 includes an outer ring 11 having a large-diameter cylindrical portion and a small-diameter cylindrical portion; an inner ring 12 disposed radially inside of the large-diameter cylindrical portion of the outer ring 11; rollers 13 and coil springs 14 mounted between the inner peripheral surface of the large-diameter cylindrical portion of the outer ring 11 and the outer peripheral surface of the inner ring 12; an unlocking piece 15 having crossbars 15a each opposed to each coil spring 14 with one of the rollers 13 disposed between the coil spring 14 and the crossbar 15a, and a side plate 16 disposed between the unlocking piece 15 and the lid 7, and mounted to the outer ring 11.

The outer ring 11 of the input switching clutch 4 has at the one end thereof a flange portion 11a including a plurality of cutouts 11b in the outer periphery of the flange portion 11a. The side plate 16 has, on the outer peripheral portion thereof, claws 16a which are fitted in some of the cutouts lib and bent to fix the side plate 16 to the flange portion 11a. The cylindrical portion 1a of the electrically driven input gear 1 has, on the inner periphery thereof, anti-rotation protrusions 1b fitted in the remainder of the cutouts 11b of the flange portion 11a, and in cutouts 16b of the side plate 16 which correspond in position to the remainder of the cutouts 11b of the flange portion 11a, respectively, so that the outer ring 11 and the side plate 16 rotate together with the electrically driven input gear 1.

The inner ring 12 has, in the one end thereof, an engaging hole 12a in which is inserted the flat surfaced section 2a, which is at the other end portion of the manually driven input shaft 2, and has, at the other end thereof, an integral hollow output shaft 17 through which the small-diameter portion of the manually driven input shaft 2 extends so that the inner ring 12 rotates about the rotation axis of the manually driven input shaft 2. The output gear 3 is fixed by keys to the outer periphery of the output shaft 17 so that the inner ring 12 and the output shaft 17 rotate together with the output gear 3. The output shaft 17 is rotatably supported by a sintered oil-containing bearing 18 fitted in the inner periphery of the small-diameter cylindrical portion of the outer ring 11.

The engaging hole 12a of the inner ring 12 has substantially the same cross-sectional shape as the flat surfaced section 2a at the other end portion of the manually driven input shaft 2, and is shaped so as to be opposed to the flat surfaced section 2a with a small gap in the rotational direction left therebetween so that the rotation of the manually driven input shaft 2 is transmitted to the inner ring 12 with a slight angular delay.

The inner ring 12 has, on its outer periphery, a plurality of cam surfaces 12b extending perpendicular to the radial direction of the inner ring 12 so that a wedge-shaped space 19 which gradually narrows toward the respective circumferential ends thereof is defined between each cam surface 12b and the inner cylindrical surface of the outer ring 11. A pair of the rollers 13 and one of the coil springs 14 are received in each wedge-shaped space 19 with the coil spring 14 disposed between the pair of rollers 13 so that the pair of rollers 13 are pushed toward the respective narrow ends of the wedge-shaped space 19 by the coil spring 14. Two of the crossbars 15a of the unlocking piece 15 are located at the respective circumferential ends of each wedge-shaped space 19. The unlocking piece 15 is fixedly fitted around the flat surfaced section 2b at the one end portion of the manually driven input shaft 2 with no gap left therebetween.

When input torque (driving force) is applied, through the electrically driven input gear 1, to the outer ring 11 of the input switching clutch 4, the rotationally forward rollers 13 are wedged into the rotationally forward narrow circumferential ends of the respective wedge-shaped spaces 19 under the biasing force of the coil springs 14, so that the outer ring 11 and the inner ring 12 become locked together through the rotationally forward rollers 13. As a result, the rotation of the outer ring 11 is transmitted to the inner ring 12, the output shaft 17, and the output gear 3. Since the crossbars 15a of the unlocking piece 15 are pushed by the rotationally forward rollers 13 at that time, the manually driven input shaft 2, to which the unlocking piece 15 is fixed, and the manual input member 10 are also rotated together with the outer ring 11.

If, as is ordinarily the case, the rotation torque of the output members (the inner ring 12, the output shaft 17, the output gear 3, and the driven member) is larger than the idle torque of the manual input members (the unlocking piece 15, the manually driven input shaft 2, and the manual input member 10), rotation is transmitted from the outer ring 11 to the inner ring 12 in the above-described manner. If, conversely, the idle torque of the manual input members is larger than the rotation torque of the output members, as soon as the outer ring 11 begins to rotates, the rotationally forward rollers 13 abut against the crossbars 15a of the unlocking piece 15, and become unable to move any further. This causes the outer ring 11 and the inner ring 12 to become unlocked from each other, and the outer ring 11 to rotate alone. Thus, if the outer ring 11 rotates independently of the inner ring 12 when input torque is applied to the outer ring 11, it is necessary to adjust the rotation torque of the output members to a value larger than the idle torque of the manual input members.

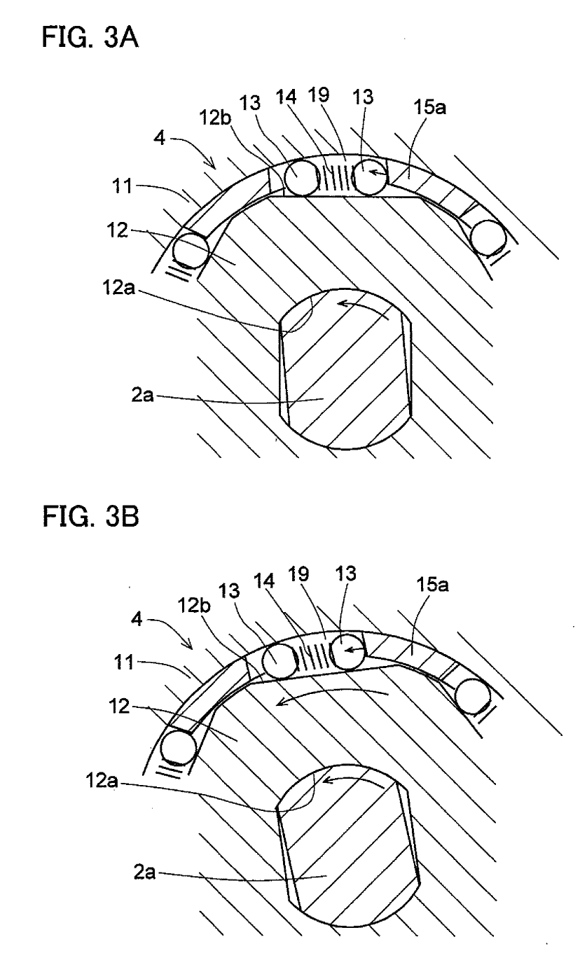

When input torque (driving force) is applied to the manually driven input shaft through the manual input member 10, the rotationally rearward rollers 13 are, as shown in FIG. 3A, pushed by the corresponding crossbars 15a of the unlocking piece 15, which is rotating together with the manually driven input shaft 2, against the elastic forces of the coil springs 14 into the wider portions of the wedge-shaped spaces 19. This causes the rotationally rearward rollers 13 to become disengaged from the outer ring 11 and the inner ring 12, thus unlocking the outer ring 11 and the inner ring 12 from each other. When the manually driven input shaft 2 rotates further in this state, the flat surfaced section 2a at the other end portion of the large-diameter portion of the manually driven input shaft 2 pushes the inner surface of the engaging hole 12a of the inner ring 12, so that, as shown in FIG. 3B, the rotation of the manually driven input shaft 2 is transmitted to the inner ring 12. This causes the rotationally forward rollers 13 to become disengaged from the outer ring 11 and the inner ring 12. As a result, the inner ring 12 and the output shaft 17 rotate together with the output gear 3.

If input torques are applied simultaneously to both the outer ring 11 and the manually driven input shaft 2, the unlocking piece 15, which is fixed to the manually driven input shaft 2, unlocks the outer ring 11 and the inner ring 12 from each other, thus preventing transmission of rotation from the outer ring 11 to the inner ring 12, and allowing transmission of rotation from the manually driven input shaft 2 to the inner ring. (Thus, in such a situation, the manual input is preferentially transmitted to the inner ring 12.)

The worm gear unit 6 is connected to the rotary shaft 5a of the driving motor 5, and is comprised of a worm gear 20 to which driving force is directly applied from the driving motor 5, and the electrically driven input gear 1, which meshes with the worm gear 20 as the worm wheel. The worm gear unit 6 has a self-locking function. That is, the worm gear unit 6 allows the electrically driven input gear 1 to be rotated by the driving force from the driving motor 5, but is configured to lock up, thereby keeping the electrically driven input gear 1 and the outer ring 11 stationary, when reverse input torque is applied to the electrically driven input gear 1 through the outer ring 11.

As described above, this driving force transmission mechanism includes two input lines (electric input line and manual input line), and one output line. While no driving force is being applied to either of the two input lines (i.e., while the driving motor 5 is not activated, and no manual input is being applied), when an external force such as gravity is applied to the driven member connected to the output gear 3, and is transmitted as reverse input torque to the electrically driven input gear 1 through the inner ring 12, which is configured to rotate together with the output gear 3, the rollers 13 and the outer ring 11, the worm gear mechanism 6 acts as a brake to prevent movement of the electrically driven input gear 1 and the outer ring 11, as well as the other output members, thus keeping the position (attitude) of the driven member unchanged.

When a driving force is applied from the driving motor 5 to the electrically driven input gear 1 through the worm gear unit 6, the driving force is transmitted to the output members through the input switching clutch 4, so that the driven member is driven.

When a driving force is applied to the manual input member 10 and the manually driven input shaft 2, the driving force is transmitted to the output members through the input switching clutch 4. At that time, since the electrically driven input gear 1 and the outer ring 11 are kept stationary by the worm gear unit 6, the driven member can be moved with a small manual force.

Thus, a driving force applied to either of the above-mentioned two input lines of this driving force transmission mechanism can be transmitted to the output members without interfering with the brake. Thus, especially when, during e.g., maintenance, moving the driven member with the manual input only, and without the electric input, the manual input member 10 can be moved easily, so that the maintenance can be carried out with high efficiency.

Since the manually driven input shaft 2 extends through the entire driving force transmission mechanism, and has its both ends rotatably supported, the driving force transmission mechanism can be easily mounted in various machines and apparatus, and once mounted in a machine, it shows high rigidity and is capable of stably transmitting driving forces.

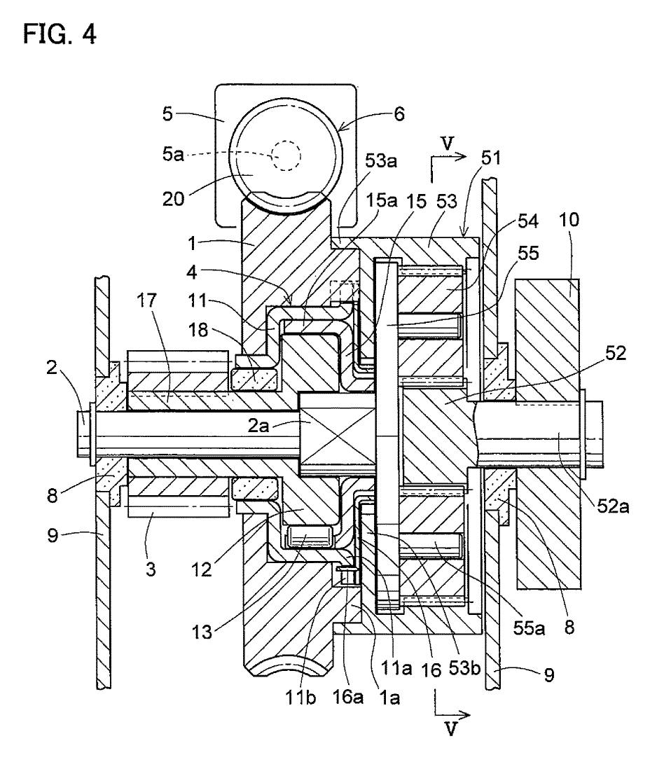

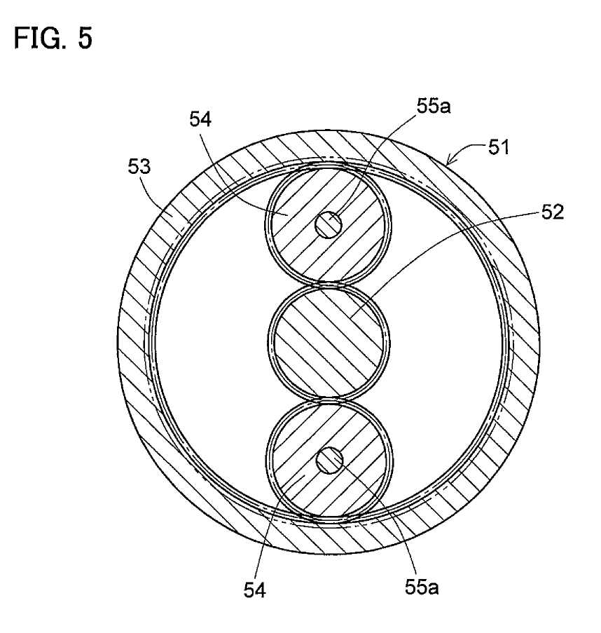

FIGS. 4 and 5 show the second embodiment of the present invention, which is basically the same as the first embodiment, and differs therefrom in that the large-diameter portion at the one end portion of the manually driven input shaft 2 is shorter than that of the first embodiment, and that a planetary gear unit (reduction gear) 51 is provided between the manually driven input shaft 2 and the manual input member 10 such that the rotation of the manual input member 10 is transmitted to the manually driven input shaft 2 after reducing its speed in the planetary gear unit 51. Here (and in the below-described further embodiments), members identical in function to those of the first embodiment are denoted by the same numerals as used in the first embodiment, and their description is omitted.

The planetary gear unit 51 comprises a sun gear 52 coaxial with the manually driven input shaft 2 and the manual input member 10; an internal gear 53 located radially outwardly of the sun gear 52, a plurality of planetary gears 54 meshing with both the sun gear 52 and the internal gear 53; and a carrier 55 supporting the planetary gears 54 for rotation about the axes of the respective planetary gears 54.

The sun gear 52 has a shaft portion 52a extending from the one end of the sun gear 52 and supported by the fixed wall member 9 through a sintered oil-containing bearing 8. The manual input member 10 is fixedly fitted on the outer periphery of the portion of the shaft portion 52a protruding beyond the wall member 9.

The internal gear 53 has a cylindrical fitting portion 53a extending from the outer peripheral portion of the other end of the internal gear 53, and fixedly fitted on the outer periphery of the cylindrical portion 1a of the electrically driven input gear 1 so that the internal gear 53 is fixed to the electrically driven input gear 1. The cylindrical fitting portion 53a is formed, on the inner periphery thereof, with a lid portion 53b as a substitute for the lid 7 of the electrically driven input gear 1 of the first embodiment.

The carrier 55 includes support shafts 55a slidably extending through the centers of the respective planetary gears 54. While the carrier 55 is integral with the manually driven input shaft 2 in the embodiment, the carrier 55 may be formed separately from the manually driven input shaft 2, and coupled thereto such that rotation can be transmitted therebetween. This embodiment is further different from the first embodiment in that the manually driven input shaft 2 has no flat surfaced section 2b at the one end portion thereof, and instead, the flat surfaced section 2a at the other end portion is longer than the flat surfaced section 2a of the first embodiment. The unlocking piece 15 is fixedly fitted on the outer periphery of the (longer) flat surfaced portion 2a.

In the second embodiment, since a planetary gear unit 51 is provided between the manually driven input shaft 2 and the manual input member 10, and its internal gear 53 is fixed to the electrically driven input gear 1 so that while the electrically driven input gear 1 is not rotating, the internal gear 53 also does not rotate, when the manual input member 10 is manually rotated, it is possible to transmit its rotation of the manual input member 10 to the manually driven input shaft 2 after reducing its speed in the planetary gear unit 51. Thus, the manual input member 10 can be rotated manually with a light force compared with the first embodiment.

When the electrically driven input gear 1 is rotationally driven by electric input, and its rotation is transmitted to the output gear 3, the carrier 55 and the internal gear 53 are rotated at the same number of revolutions because (1) the rotation of the electrically driven input gear 1 is transmitted to the carrier 55 through the rollers 13 of the input switching clutch 4, which is located in the drive path, the unlocking piece 15, and the manually driven input shaft 2, and (2) the internal gear 53 is fixed to the electrically driven input gear 1. Thus, the planetary gears 54 orbit the sun gear 52 without rotating about their own axes, and thus, as though the planetary gears 54, the internal gear 53, and the sun gear 52 were an integral body, so that the planetary gear unit 51 does not increase the rotation of the electrically driven input gear 1 when it is transmitted to the sun gear 52 and the manual input member 10. This means that when the electrically driven input gear 1 is rotated, the manual input member 10 of this embodiment is rotated, not at a higher speed than, but at the same speed as, the electrically driven input gear 1, and thus the manual input member 10 of the first embodiment.

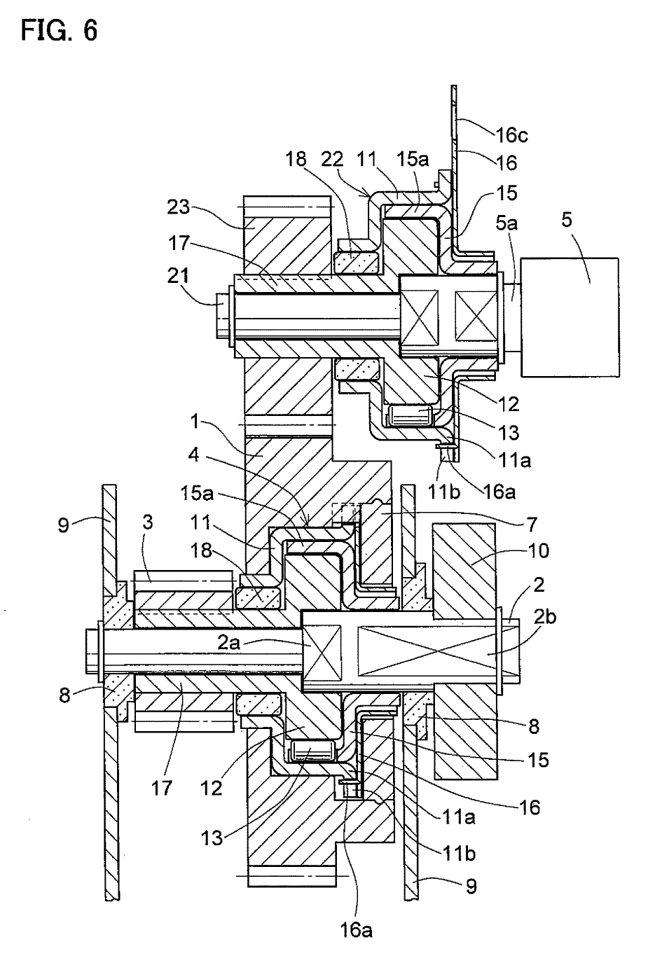

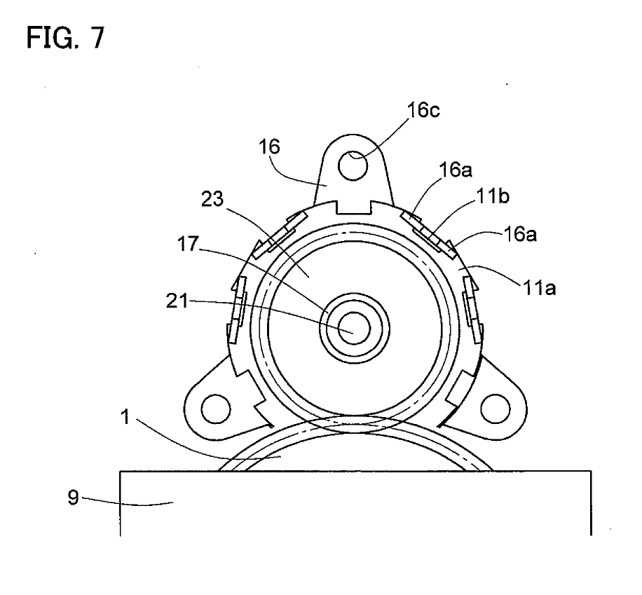

FIGS. 6 and 7 show the third embodiment of the present invention, which is basically the same as the first embodiment, and is different therefrom in that an electrically driven input shaft 21 is connected to the rotary shaft 5a of the driving motor 5; that the electrically driven input gear 1 is in the form of a spur gear; and that instead of the worm gear unit 6, a reverse input blocking clutch 22 is provided as a brake such that the driving force of the driving motor 5 is transmitted to the electrically driven input gear 1 through the electrically driven input shaft 21, and the reverse input blocking clutch 22.

The electrically driven input shaft 21 is substantially of the same structure as the manually driven input shaft 2, and differs therefrom only in that it is connected to the rotary shaft 5a of the driving motor 5, so that no manual input member 10 is fixedly fitted thereon, and that neither of its ends is supported by a bearing.

The reverse input blocking clutch 22 is substantially identical in structure to the input switching clutch 4 of the first embodiment, and differs therefrom in that (1) the side plate 16 mounted to the outer ring 11 has a tongue portion protruding from the outer periphery of the side plate 16 and mounted to a fixed member, not shown, using a mounting hole 16c formed in the tongue portion so that the outer ring 11 and the side plate 16 are fixed in position; and (2) a coupling gear 23 meshing with the electrically driven input gear 1 is fixed by keys to the outer periphery of the output shaft 17 integral with the inner ring 12.

When reverse input torque is applied to the from the coupling gear 23 to the output shaft 17 and the inner ring 12 of the reverse input blocking clutch 22, since the rotationally rearward rollers 13 are pushed into the narrow portions of the wedge-shaped spaces 19 under the elastic forces of the coil springs 14, and are in engagement with the outer ring 11 and the inner ring 12, so that the inner ring 12 becomes locked to the outer ring 11, which is in turn fixed to the fixed member, and remains stationary along with the output shaft 17 and the coupling gear 23.

When a driving force is applied from the driving motor 5 to the electrically driven input shaft 21, the reverse input blocking clutch 22 operates in the same manner as the input switching clutch 4. In particular, when input torque is applied to the electrically driven input shaft 21, the unlocking piece 15 rotates together with the electrically driven input shaft 21, so that crossbars 15a of the unlocking piece 15 push the rotationally rearward rollers 13 into the wide portions of the wedge-shaped spaces 19 against the elastic forces of the coil springs 14, thereby unlocking the outer ring 11 and the inner ring 12 from each other. When the electrically driven input shaft 21 further rotates thereafter, and pushes the inner ring 12, the rotation of the electrically driven input shaft 21 is transmitted to the inner ring 12, so that the inner ring 12 and the output shaft 17 rotate together with the coupling gear 23.

Thus, the reverse input blocking clutch 22 includes a locking means for locking the output portion (i.e., the portion coupled to the electrically driven input gear 1 such that rotation can be transmitted to the electrically driven input gear 1, and comprising the inner ring 12, the output shaft 17, and the coupling gear 23) to the fixed member; an unlocking means for unlocking the output portion from the fixed member when rotation is applied to the input portion (i.e., the electrically driven input shaft 21, to which a driving force is applied); and means for transmitting the rotation of the input portion to the output portion with a slight angular delay when the output portion is unlocked from the fixed member.

In the driving force transmission mechanism of the third embodiment, while no driving force is being applied to either of the two input lines, when an external force applied to the driven member is transmitted as reverse input torque to the reverse input blocking clutch 22 through the input switching clutch 4, the electrically driven input gear 1, and the coupling gear 23, the reverse input blocking clutch 22 acts as a brake to keep the position of the driven member unchanged. When an electric driving force is applied from the driving motor 5 to the electrically driven input gear 1 through the reverse input blocking clutch 22, or when a manual driving force is applied to the manual input member 10 and the manually driven input shaft 2, either of these driving forces is transmitted to the output line through the input switching clutch 4, and moves the driven member. While only a manual force is being applied, since the reverse input blocking clutch 22 keeps the electrically driven input gear 1 and the outer ring 11 stationary, the driven member can be moved manually with a light force. Thus, as with the first embodiment, this embodiment makes it possible to move the driven member manually with a light force, thus improving the efficiency of maintenance.

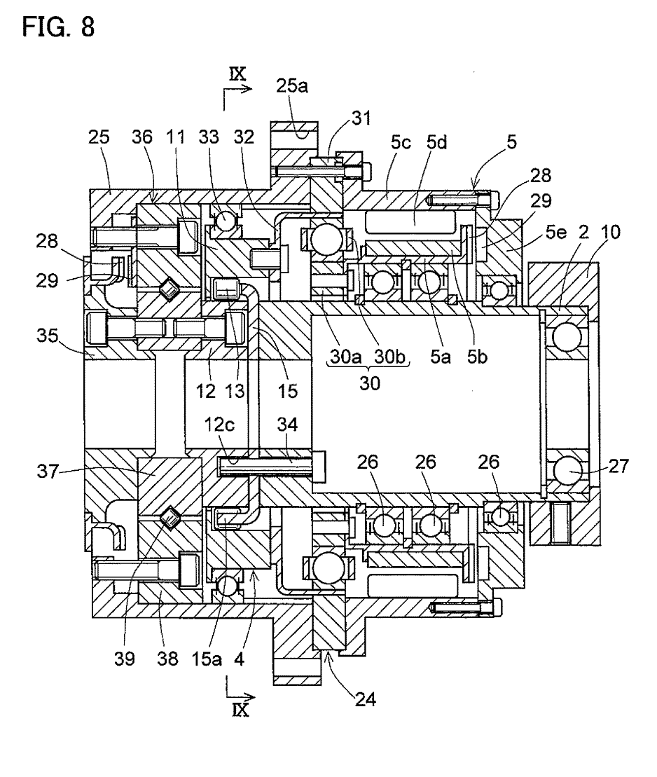

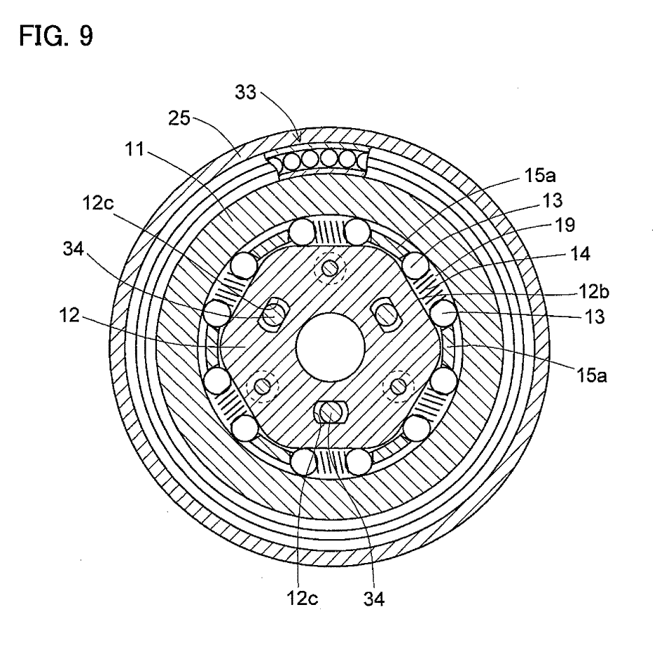

FIGS. 8 and 9 show the fourth embodiment of the present invention, which differs from the first embodiment in that the input switching clutch 4 of the first embodiment is partially modified; that a hollow space is formed that extends through the entire driving force transmission mechanism so that a cable can be passed therethrough; and that instead of the worm gear unit 6, a wave gear unit 24 is used as a brake. This embodiment also differs from the first embodiment in the support structure of the entire driving force transmission mechanism, and the structure of the output line. These differences are now described.

The driving force transmission mechanism of the fourth embodiment includes a housing 25 in which is received the input switching clutch 4 and the output members, and is, in its entirety, fixedly supported in a joint driving unit of a robot by using mounting holes 25a formed in a flange portion of the housing 25 at its one end.

The hollow space extending through the entire driving force transmission mechanism is formed by hollow spaces defined in the manually driven input shaft 2, the driving motor 5, and the inner ring 12 of the input switching clutch 4. The manually driven input shaft 2 includes no portion extending toward the output members, and is rotatably supported by the inner periphery of the driving motor 5 through three ball bearings 26. As will be described hereinafter, the outer members also have hollow spaces. Another ball bearing 27 is provided at the one end of the inner periphery of the manually driven input shaft 2 so that the manually driven input shaft 2 can rotate smoothly without interfering with e.g., the cable passed through the driving force transmission mechanism.

The driving motor 5 includes a hollow rotary shaft 5a, a rotor 5b mounted on the outer periphery of the rotary shaft 5a, a motor housing 5c, a stator 5d mounted on the inner periphery of the motor housing 5c, and a lid 5e closing the one end of the motor housing 5c. The driving motor 5 has a built-in rotation detector comprising a magnetic wheel 28 mounted on an outer side surface of a flange portion of the rotary shaft 5a at its one end, and a sensor 29 mounted on the inner side surface of the lid Se to face the magnetic wheel 28.

The wave gear unit 24 includes a wave generator 30 joined by bolts to an inwardly extending flange portion of the rotary shaft 5a of the driving motor 5 at its other end, a circular spline 31 arranged radially outwardly of the wave generator 30, and a flex spline 32 having a large-diameter portion sandwiched between the wave generator 30 and the circular spline 31.

The wave generator 30 includes a cam 30a having an oval diametric section, and a ball bearing 30b having an inner race fixedly fitted on the outer periphery of the cam 30a. The circular spline 31 is an annular member having teeth on the inner periphery thereof, and is sandwiched between, and fixedly joined by bolts to, the housing 25 and the motor housing 5c of the driving motor 5. The flex spline 32 is a thin-walled, cup-shaped member made from a metal elastic body. The flex spline 32 has teeth formed on the outer periphery of the large-diameter portion of the flex spline 32 to mesh with the teeth on the inner periphery of the circular spline 31, and includes a small-diameter portion joined by bolts to the outer ring 11 of the input switching clutch 4. The flex spline 32 thus takes the place of the electrically driven input gear 1 of the first embodiment as the first input member.

The wave gear unit 24 is configured such that when the wave generator 30 is rotated under the driving force of the driving motor 5, the outer race of the ball bearing 30b of the wave generator 30 presses the inner periphery of the large-diameter portion of the flex spline 32, thus causing the flex spline 32 to be elastically deformed such that the flex spline 32 rotates together with the outer ring 11 of the input switching clutch 4 at a speed corresponding to the difference in number between the teeth of the flex spline 32 and the circular spline 31 due to the movement of the meshing position between the flex spline 32 and the circular spline 31.

Since, as will be apparent from the above description, the reduction ratio of this wave gear unit 24 is as large as that of the worm gear unit 6 of the first embodiment, the wave gear unit 24 has a self-locking function. That is, while the flex spline 32 rotates under the driving force of the driving motor 5, the flex spline 32 locks up when reverse input torque is applied to the flex spline 32 through the outer ring 11 of the input switching clutch 4, thus keeping the outer ring 11. stationary. The wave gear unit 24 thus acts as a brake of the driving force transmission mechanism.

The input switching clutch 4 is partially different in structure from that of the first embodiment. First, the outer ring 11 is, as described above, joined to the flex spline 32 of the wave gear unit 24 for rotation together with the flex spline 32, and is rotatably supported by the housing 25 through a ball bearing 33. The inner ring 12 is, as described above, a hollow member, and has, instead of the engaging hole 12a of the first embodiment, a plurality of circumferentially spaced apart, elongated engaging holes 12c in the one end surface of the inner ring 12. The manually driven input shaft 2 has input pins 34 protruding from the other end thereof, and each having its distal end portion inserted in one of the engaging holes 12c with a circumferential gap left therebetween. The input pins 34 extend through the unlocking piece 15, coupling the unlocking piece 15 to the manually driven input shaft 2 so as to rotate together with the manually driven input shaft 2.

The input switching clutch 4 of this embodiment operates substantially in the same manner as the counterpart of the first embodiment. In particular, when input torque is applied to the outer ring 11 through the flex spline 32, the rotation of the outer ring 11 is transmitted to the inner ring 12, and simultaneously, the rotationally forward rollers 13 push the crossbars 15a of the unlocking piece 15. As a result, the manually driven input shaft 2 and the manual input member 10 rotate together with the unlocking piece 17. When input torque is applied to the manually driven input shaft 2 through the manual input member 10, the crossbars 15a of the unlocking piece 15 unlock the outer ring 11 and the inner ring 12 from each other, and then, the input pins 34 push the inner surfaces of the engaging holes 12c of the inner ring 12, thereby transmitting the rotation of the manually driven input shaft 2 to the inner ring 12. When input torques are simultaneously applied to the outer ring 11 and the manually driven input shaft 2, rotation is transmitted from the manually driven input shaft 2 to the inner ring 12.

In the fourth embodiment, as in the first embodiment, either of the driving forces applied to electric input line and the manual input line can be transmitted to the output line without interfering with the brake.

The driving force transmission mechanism of the fourth embodiment does not include the output gear 3 and the output shaft 17 of the first embodiment, and includes a cross roller bearing 36 between the inner ring 12 of the input switching clutch 4 and a hollow connecting member 35 provided instead of the output shaft 17 and connected, as an output member, to the driven member. The cross roller bearing 36 includes a plurality of rollers 39 disposed between a hollow inner race 37 and an outer race 38 such that the circumferentially adjacent rollers 39 cross each other at a right angle. The inner race 37 is joined by bolts to, so as to rotate together with, the inner ring 12 of the input switching clutch 4 and the connecting member 35, while the outer race 38 is joined to the housing 25 by bolts, so that the entire driving force transmission mechanism of this embodiment shows increased rigidity against thrust forces, and thus rotation can be transmitted stably.

An additional rotation detector similar to the rotation detector mounted in the driving motor 5 is provided between the outer race 38 of the cross roller bearing 36 and the connecting member 35. The additional rotation detector includes a magnetic wheel 28 mounted to the connecting member 35, and a sensor 29 mounted on the outer side surface of the outer race 38 of the cross roller bearing 36 to face the magnetic wheel 28. It is possible to rotate the connecting member 35 with high accuracy by correcting the number of revolutions of the driving motor 5 such that the number of revolutions of the connecting member 35 coincides with the target number of revolutions, based on the number of revolutions of the connecting member 35 as detected by the additional rotation detector, and the number of revolutions of the driving motor 5 as detected by the rotation detector mounted in the driving motor 5.

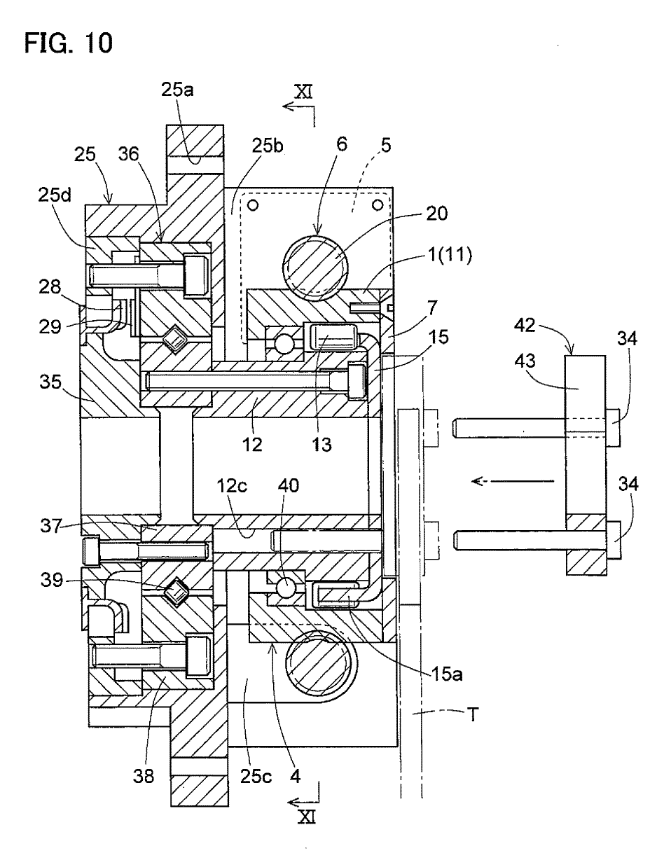

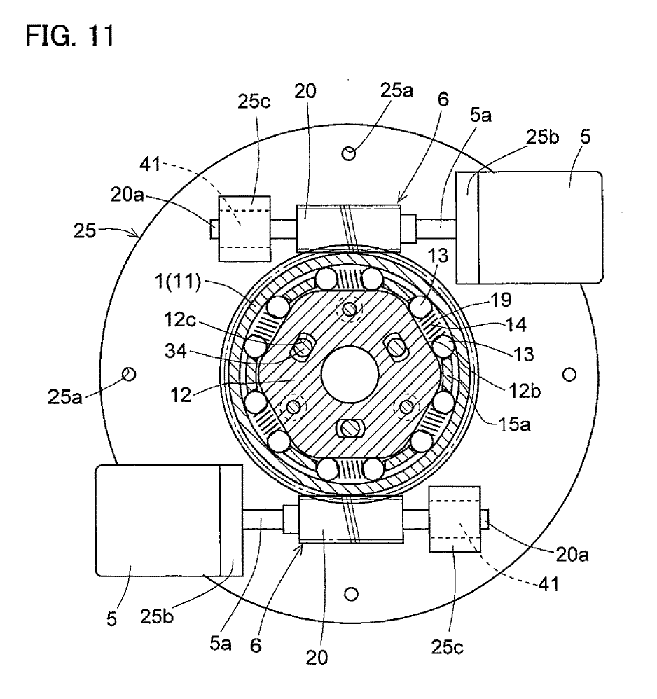

FIGS. 10-13 show the fifth embodiment of the present invention, which is basically the same as the fourth embodiment, and differs therefrom in that the electric input line of the first embodiment is partially modified in structure, and the manual input line of the first embodiment is changed in structure. A driving force is transmitted basically in the same manner as in the fourth embodiment. The above-mentioned differences are now described.

The electric input line of the fifth embodiment comprises an electrically driven input gear 1 integral with the outer ring 11 of the input switching clutch 4, two worm gear assemblies 6 of which the electrically driven input gear 1 serves as a common worm wheel, and two driving motors 5 each connected to the one end of the worm gear 20 of each worm gear unit 6. While not shown, each driving motor 5 has a built-in rotation detector similar to the one used in the fourth embodiment.

A lid 7 is fixed by screws to the electrically driven input gear 1 to close its opening at the one end thereof. A ball bearing 40 is disposed between the electrically driven input gear 1 and the inner ring 12 of the input switching clutch 4 to rotatably support the inner ring 12.

The rotary shafts 5a of the driving motors 5 extend through, and fixed to, respective motor fixing portions 25b provided at the one end surface of the housing 25. Each worm gear 20 has, at its end remote from the driving motor 5, a small-diameter non-threaded portion 20a rotatably supported by a bearing 41 fixed to a bearing fixing portion 25c on the one end surface of the housing 25. The housing 25 has a short axial length such that the input switching clutch 4 is not received in the housing 25. The outer race 38 of the cross roller bearing 36 is fixed to a bearing fixing plate 25d which is a separate member from the housing 25, and which is fixedly fitted in the inner periphery of the housing 25 at the other end of the housing 25.

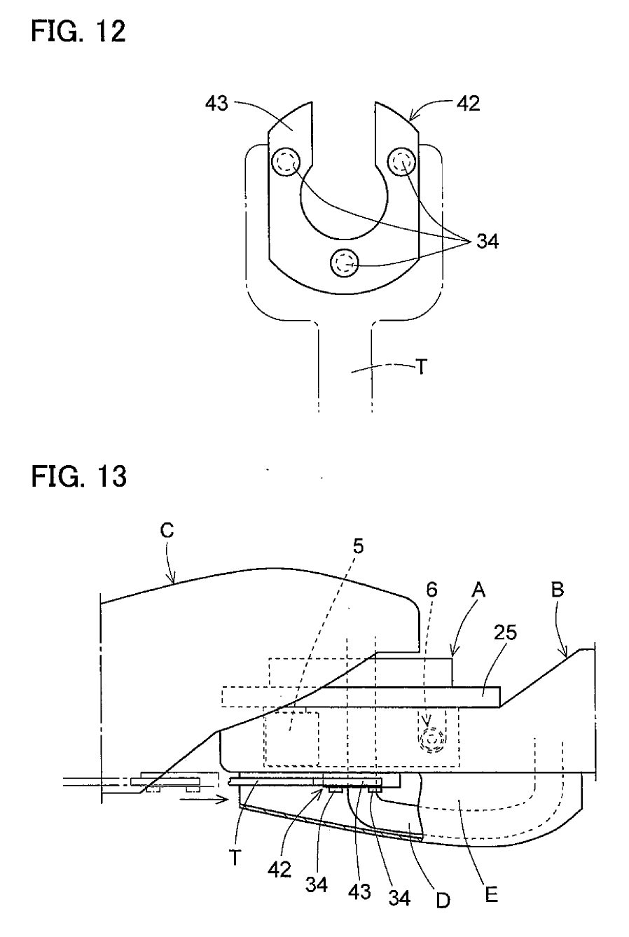

For the manual input line, instead of the manually driven input shaft 2, the unlocking piece 15 of the input switching clutch 4 and a manual input jig 42 detachably mounted to the inner ring 12 are used as second input members. The manual input jig 42 comprises a substantially U-shaped control plate 43, and a plurality of input pins 34 extending through the control plate 43 in the thickness direction of the control plate 43. As with the input pins of the fourth embodiment, the input pins 34 of this embodiment are configured to be inserted through the unlocking piece 15 without gaps therebetween, and inserted into the elongated engaging holes 12c in the inner ring 12 with circumferential gaps left therebetween. Thus, when the manual input jig 42 is fitted in position (by inserting the input pins 34 through the unlocking piece 15 and into the inner ring 12), and rotated with a tool (spanner) T having the shape as shown by one-dot chain line of FIG. 12, in the same manner as in the fourth embodiment, the outer ring 11 and the inner ring 12 are unlocked from each other by the crossbars 15a of the unlocking piece 15, and thereafter, the input pins 34 push the inner surfaces of the engaging holes 12c of the inner ring 12, thereby transmitting the rotation of the manual input jig 42 to the inner ring 12.

As shown in FIG. 13, the driving force transmission mechanism A of the fifth embodiment is mounted in a robot arm, with the housing 25 fixed to a driving arm B, with the members on the input side of the housing 25 received in the driving arm B, and with the connecting member 35 connected to a driven arm C as the driven member. A cable D extending from inside the driving arm B extends through the driving force transmission mechanism A, and is introduced into the driven arm C. Thus, the driven arm C can be manually moved for e.g., maintenance by removing a cover E provided on the surface of the driving arm B opposite from its surface facing the driven arm C, setting the manual input jig 42 to axially face the unlocking piece 15 with the cable D received in a cutout in the control plate 43, inserting the input pins 34 through the unlocking piece 15 and into the inner ring 12, fitting the tool T on the outer periphery of the control plate 43, and turning the tool T.

In the fifth embodiment, although the driving force transmission mechanism has a hollow space extending through the entire driving force transmission mechanism as in the fourth embodiment, since the electric input line is configured such that the electrically driven input gear 1 is rotationally driven by driving motors 5 arranged at positions offset from the center axis of the driving force transmission mechanism through the worm gear assemblies 6, it is possible to use ordinary motors for the driving motors 5, thus making it possible to reduce the manufacturing cost and the maintenance cost, compared with the fourth embodiment, in which a special hollow motor 5 is used.

Also, for the manual input line, since a detachable manual input jig 42 is used instead of the manually driven input shaft 2 of the fourth embodiment, the entire driving force transmission mechanism is compact in size and thus lightweight compared with the fourth embodiment.

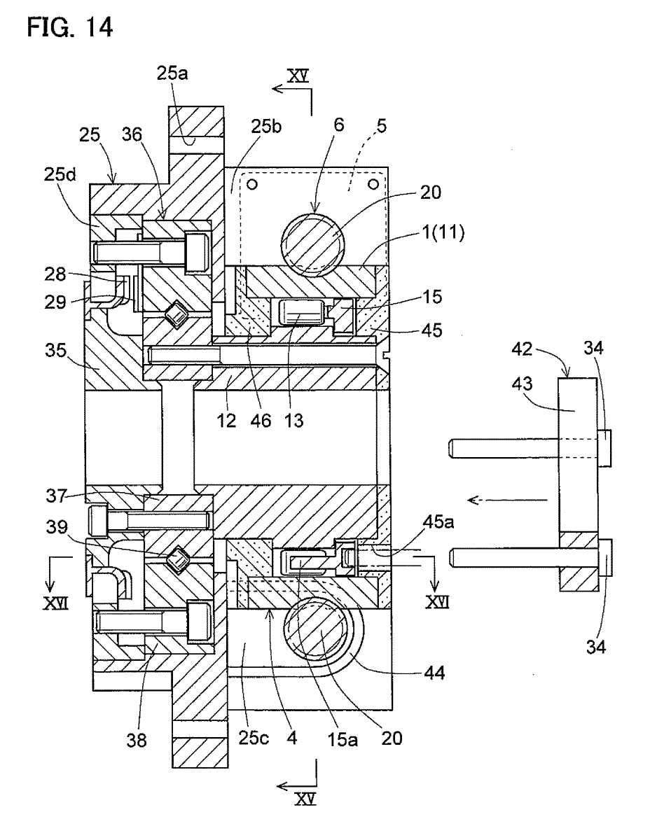

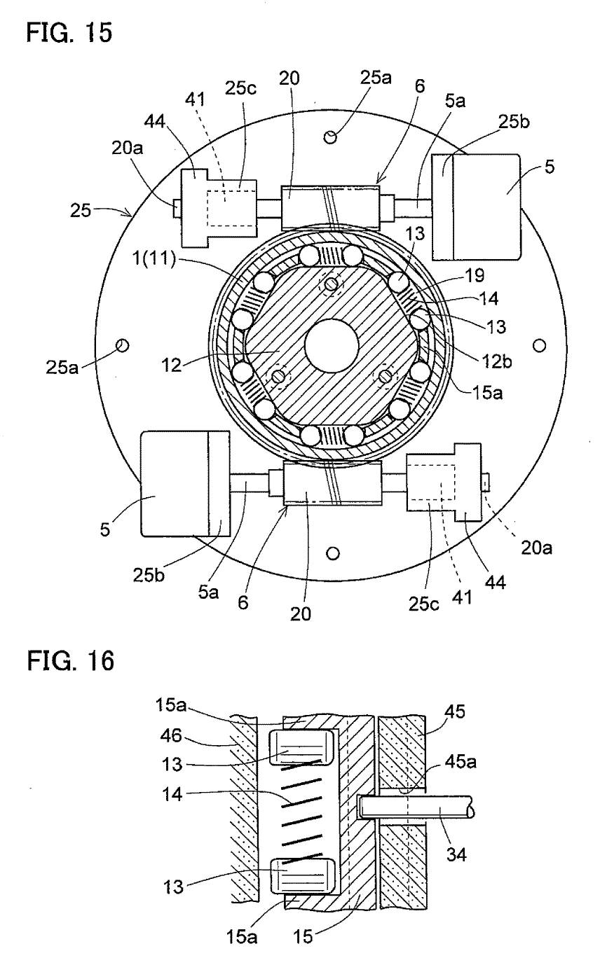

FIGS. 14-16 show the sixth embodiment, which differs from the fifth embodiment in that the electric input line is partially modified, but the driving force is transmitted basically in the same manner as the fifth embodiment. Below, only what differs from the fifth embodiment is described.

For the electric input line of the sixth embodiment, as with the fifth embodiment, the bearings 41 supporting the non-threaded portions 20a of the respective worm gears 20 are fixed to the bearing fixing portions 25c of the housing 25. However, this embodiment differs from the fifth embodiment in that each bearing fixing portion 25c is provided with a rotation detector 44 used to control the corresponding driving motor 5, and that the driving motor 5 has no built-in rotation detector. By providing a rotation detector 44 for controlling each driving motor 5 separately from the driving motor 5, and by using driving motors 5 having no built-in rotation detectors, it is possible to reduce the size of the entire driving force transmission mechanism compared with the fifth embodiment, while maintaining as high accuracy of rotation detection as with the fifth embodiment.

Between the electrically driven input gear 1 (i.e., the outer ring 11 of the input switching clutch 4) and the inner ring 12 of the input switching clutch 4, sintered oil-containing bearings 45 and 46 are provided which are in sliding contact with the electrically driven input gear 1, instead of the lid 7 and the ball bearing 40 of the fifth embodiment. One of these two bearings 45 and 46 is joined by bolts to the one end of the inner ring 12, while the other of the bearings is 45 and 46 is joined by bolts to the outer periphery of the inner ring 12 at the other end of the inner ring 12.

The unlocking piece 15 of the input switching clutch 4 of this embodiment has no radially extending portion, and is arranged and shaped such that the tips of the input pins 34 of the manual input jig 42 can be inserted into portions of the unlocking piece 15 between adjacent crossbars 14 without circumferential gaps therebetween. As a result, the inner ring 12 has no engaging holes 12c in which the input pins 34 are to be inserted, and instead, the sintered oil-containing bearing 45, which is joined by bolts to the inner ring 12, is formed with circular engaging holes 45a into which the input pins 34 can be inserted with circumferential gaps left therebetween so that, as in the fifth embodiment, a manual driving force can be applied from the manual input jig 42.

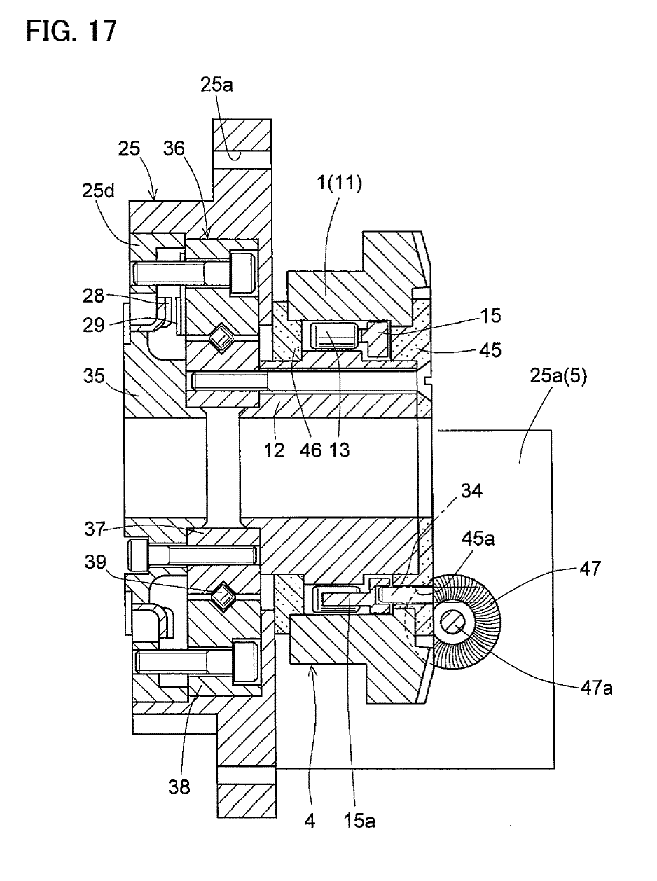

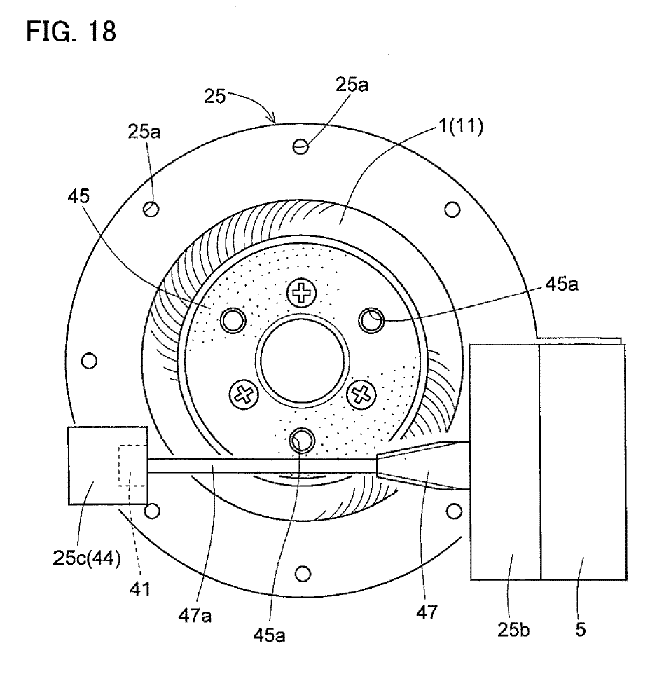

FIGS. 17 and 18 show the seventh embodiment, in which instead of the two worm gear assemblies 6 of the sixth embodiment, a reverse input blocking unit is used which comprises a pinion shaft 47 to which the driving force from a driving motor 5 is directly applied, and an electrically driven input gear 1 in the form of a helical bevel gear meshing with the pinion shaft 47. Since this reverse input blocking unit has a structural feature that a reduction ratio larger than that of the worm gear assemblies 6 is easily obtainable, it serves as a brake due to its self-locking function in the same manner as the worm gear assemblies 6. In FIGS. 17 and 18, the manual input jig 42 is not shown.

The electrically driven input gear 1 of this reverse input blocking unit is, as with the counterpart of the sixth embodiment, integral with the outer ring 11 of the input switching clutch 4. The pinion shaft 47 is rotatably supported at its proximal end by a bearing (not shown) mounted in a motor fixing portion 25b of the housing 25. The pinion shaft 47 has a shaft portion 47a axially extending from the distal end of the pinion shaft 47, and rotatably supported by a bearing 41 fixed to a bearing fixing portion 25c of the housing 25. The driving motor 5 is controlled based on the rotation of the driving motor 5 as detected by a rotation detector 44 provided at the bearing fixing portion 25c.

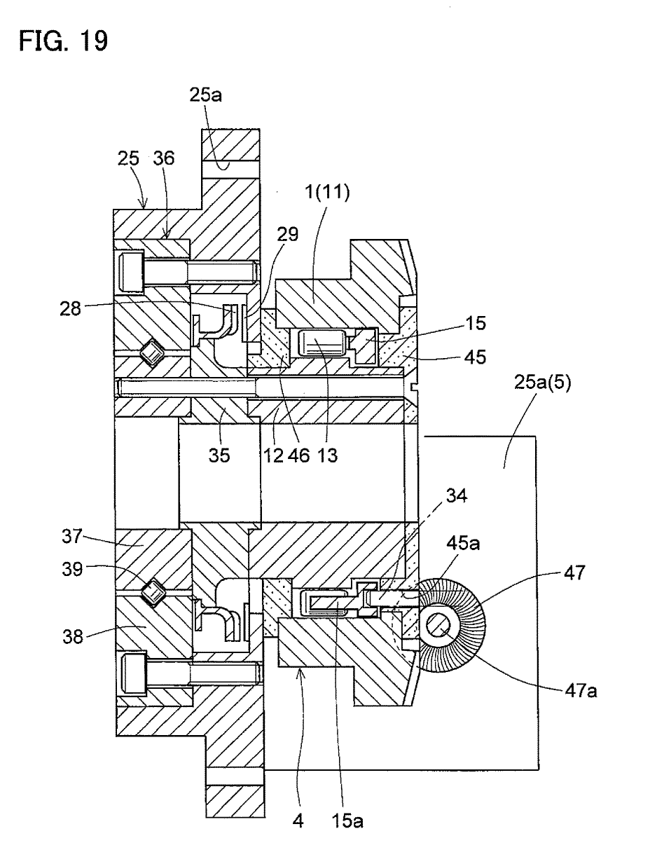

FIG. 19 shows the eighth embodiment, in which the positions of the connecting member 35 and the cross roller bearing 36 of the seventh embodiment are reversed such that the inner race 37 of the cross roller bearing 36 serves as the output member to be connected to the driven member. The connecting member 35 and the inner race 37 of the cross roller bearing 36 are joined to, so as to rotate together with, the inner ring 12 of the input switching clutch 4 by means of common bolts. A rotation detector is provided which comprises a magnetic wheel 28 mounted to the connecting member 35, and a sensor 29 mounted to the inner surface of the housing 25 to face the magnetic wheel 28, and which is configured to detect the number of revolutions of the inner race 37 of the cross roller bearing 36 which rotates together with the connecting member 35.

In the eighth embodiment, since the rotation detector for detecting the number of revolutions of the inner race 37 of the cross roller bearing 36 as the output member is located inside of the outer race 38 of the cross roller bearing 36, which serves as a fixed cover member covering the output member from radially outside of the output member, and inside of the housing 25, the rotation detector is protected against foreign matter. By forming the outer race 38 of the cross roller bearing 36 and the housing 25 from metal, the rotation detector can be protected against electromagnetic noise too. Thus, compared with the seventh embodiment, the number of revolutions of the inner race 37 of the cross roller bearing 36 can be detected with high accuracy, so that the driven member connected to the inner race 37 can be positioned with high accuracy.

The input switching clutch according to the present invention is not limited to those of the above-described embodiments, provided it includes an outer ring configured to rotate together with the first input member, an inner ring provided radially inwardly of the outer ring, and configured to rotate about the rotation axis of the second input member together with the output shaft, and a plurality of rollers disposed between the outer ring and the inner ring, and is configured such that when a driving force is applied to the first input member, the outer ring becomes locked to the inner ring through the rollers so that the driving force is transmitted to the inner ring and the output member, and such that when a driving force is applied to the second input member, and the second input member is rotated, the outer ring and the inner ring are unlocked from each other first, and thereafter, the driving force is transmitted to the inner ring and the output member.

While the helical gears of the first, second, fifth and sixth embodiments, the flex spline of the fourth embodiment, and the helical bevel gear of the seventh embodiment are shown to be integral with the first input member, they may be formed separately from the first input member, and coupled to the first input member so that rotation can be transmitted to the first input member. While the outer ring of the input switching clutch of each of the fifth to seventh embodiments are integral with the first input member, the former may be formed separately from the latter, and coupled to the later so that rotation can be transmitted to the latter.

The concept of the present invention is applicable not only to a driving force transmission mechanism to be mounted in a joint driving unit of an industrial robot, such as shown in the above-described embodiments, but to other driving force transmission mechanisms including two input lines, one output line, and a brake.

### DESCRIPTION OF THE NUMERALS

1. Electrically driven input gear (first input member)
2. Manual driven input shaft (second input member)
3. Output gear (output member)
4. Input switching clutch
5. Driving motor
6. Worm gear unit (reverse input blocking unit)
10. Manual input member
11. Outer ring
12. Inner ring
13. Roller
14. Coil spring
15. Unlocking piece
15a. Crossbar
17. Output shaft
19. Wedge-shaped space
20. Worm gear
21. Electrically driven input shaft
22. Reverse input blocking clutch (reverse input blocking unit)
23. Coupling gear
24. Wave gear unit (Reverse input blocking unit)
25. Housing
30. Wave generator
31. Circular spline
32. Flex spline (first input member)
34. Input pin
35. Connecting member (output member)
36. Cross roller bearing
42. Manual input jig (second input member)
43. Control plate
44. Rotation detector
47. Pinion shaft
47a. Shaft portion
51. Planetary gear unit (reduction gear)
52. Sun gear
53. Internal gear
54. Planetary gear
55. Carrier
A. Driving force transmission mechanism
B. Driving arm
C. Driven arm
D. Cable
E. Cover
T. Tool

1. A driving force transmission mechanism comprising:
a first input member;
a second input member;
an output member;
an input switching clutch coupled to the first input member, the second input member, and the output member, and configured to selectively transmit either one of first and second driving forces for rotationally driving the first input member and the second input member, respectively, to the output member, and
a reverse input blocking unit mounted in an input side of the first input member, and configured to allow transmission of the first driving force, which is applied from a driving source, to the first input member, and to lock up when reverse input is applied to the first input member through the input switching clutch, thereby keeping the first input member stationary,
the input switching clutch including:
an outer ring configured to rotate together with the first input member;
an inner ring provided radially inwardly of the outer ring, and configured to rotate about a rotation axis of the second input member together with the output shaft; and
a plurality of rollers disposed between the outer ring and the inner ring,
wherein the input switching clutch is configured such that when the first driving force is applied to the first input member through the reverse input blocking unit, the outer ring becomes locked to the inner ring through the rollers so that the first driving force is transmitted to the inner ring and the output member, and such that when the second driving force is applied to the second input member, and the second input member is rotated under the second driving force, the outer ring and the inner ring are unlocked from each other first, and thereafter, the second driving force is transmitted to the inner ring and the output member.

2. The driving force transmission mechanism of claim 1,
wherein the inner ring of the input switching clutch has an outer periphery including a plurality of circumferentially arranged cam surfaces, and the outer ring of the input switching clutch has a cylindrical inner peripheral surface, to define, between each of the cam surfaces and the cylindrical inner peripheral surface, a wedge-shape space which narrows gradually toward respective circumferential ends thereof, and in which two of the rollers and a spring are mounted such that the rollers are pushed by the spring into respective narrow circumferential end portions of the wedge-shaped space,
wherein the input switching clutch further includes an unlocking piece having crossbars inserted on both circumferential sides of the respective wedge-shaped spaces, and coupled to the second input member such that rotation can be transmitted to the second input member,
wherein a torque transmission arrangement is provided between the second input member and the inner ring such that rotation of the second input member is transmitted to the inner ring through the torque transmission arrangement with a slight angular delay,
wherein the driving force transmission device is configured such that when the first driving force is applied to the first input member, the outer ring, which is configured to rotate together with the first input member, becomes locked to the inner ring through the rollers so that the first driving force is transmitted to the inner ring and the output member, and such that when the second driving force is applied to the second input member, one of the two rollers in each of the wedge-shaped spaces, which are opposed to each other in a rotational direction, is pushed toward a wide portion of the wedge-shaped space by corresponding ones of the crossbars of the unlocking piece, which is configured to rotate together with the second input member, against an elastic force of the spring in the wedge-shaped space so that the outer ring and the inner ring are unlocked from each other, and thereafter, the second driving force is transmitted to the inner ring and the output member through the torque transmission arrangement.

3. The driving force transmission mechanism of claim 1, wherein the first driving force is an electric driving force, and the second driving force is a manual driving force.

4. The driving force transmission mechanism of claim 3, which is formed with a hollow space extending through the entire driving force transmission mechanism.

5. The driving force transmission mechanism of claim 1, wherein the reverse input blocking unit is a worm gear unit including a worm gear configured such that the first driving force is applied to the worm gear, and a worm wheel meshing with the worm gear and coupled to the first input member such that rotation can be transmitted to the first input member, the reverse input blocking unit having a self-locking function.

6. The driving force transmission mechanism of claim 1, wherein the reverse input blocking unit includes a pinion shaft configured such that the first driving force is applied to the pinion shaft, and a helical bevel gear meshing with the pinion shaft and coupled to the first input member such that rotation can be transmitted to the first input member, the reverse input blocking unit having a self-locking function.

7. The driving force transmission mechanism of claim 1, wherein the reverse input blocking unit is a reverse input blocking clutch including an input portion configured such that the first driving force is applied to the input portion, an output portion coupled to the first input member such that rotation can be transmitted to the first input member, a locking arrangement configured to lock the output portion to a fixed member, an unlocking arrangement configured to unlock the output portion from the fixed member when the input portion rotates, and an arrangement configured to transmit rotation of the input portion to the output portion with a slight angular delay when the output portion is unlocked from the fixed member.

8. The driving force transmission mechanism of claim 1, wherein the reverse input blocking unit includes a wave generator configured such that the first driving force is applied to the wave generator, a circular spline fixed at a position radially outwardly of the wave generator, and a flex spline disposed between the wave generator and the circular spline, and coupled to the first input member such that rotation can be transmitted to the first input member, the reverse input blocking unit having a self-locking function.

9. The driving force transmission mechanism of claim 1, wherein the second input member extends through the entire driving force transmission mechanism, and has two rotatably supported ends.

10. The driving force transmission mechanism of claim 1, wherein the second input member is detachable from the unlocking piece and the inner ring.

11. The driving force transmission mechanism of claim 1, wherein the second driving force is a manual driving force, and wherein the driving force transmission mechanism further comprises a manual input member configured to be operated under the manual driving force, and a reduction unit disposed between the second input member and the manual input member, and configured to transmit, after reducing, rotation of the manual input member to the second input member.

12. The driving force transmission mechanism of claim 11, wherein the reduction unit is a planetary gear unit comprising a sun gear configured such that the manual driving force is applied to the sun gear from the manual input member, an internal gear disposed radially outwardly of the sun gear, a plurality of planetary gears meshing with the sun gear and the internal gear, and a carrier supporting the planetary gears such that each of the planetary gears is rotatable about an axis of the planetary gear, and coupled to the second input member such that rotation can be transmitted to the second input member, and wherein the internal gear is integral with the first input member.

13. The driving force transmission mechanism of claim 1, wherein the driving source is a driving motor, the first driving force is an electric driving force, and the driving force transmission mechanism further comprises a rotation detector which is a separate member from the driving motor and configured to control the driving motor.

14. The driving force transmission mechanism of claim 13, wherein the rotation detector is coaxial with the driving motor.

15. The driving force transmission mechanism of claim 1, further comprising a rotation detector disposed inside of a fixed cover member covering the output member from radially outside of the output member, and configured to detect a number of revolutions of the output member.

16. The driving force transmission mechanism of claim 1, wherein the driving force transmission mechanism is mounted in a joint driving unit of a robot.

17. The driving force transmission mechanism of claim 2, wherein the reverse input blocking unit is a worm gear unit including a worm gear configured such that the first driving force is applied to the worm gear, and a worm wheel meshing with the worm gear and coupled to the first input member such that rotation can be transmitted to the first input member, the reverse input blocking unit having a self-locking function.

18. The driving force transmission mechanism of claim 2, wherein the reverse input blocking unit includes a pinion shaft configured such that the first driving force is applied to the pinion shaft, and a helical bevel gear meshing with the pinion shaft and coupled to the first input member such that rotation can be transmitted to the first input member, the reverse input blocking unit having a self-locking function.

19. The driving force transmission mechanism of claim 2, wherein the reverse input blocking unit is a reverse input blocking clutch including an input portion configured such that the first driving force is applied to the input portion, an output portion coupled to the first input member such that rotation can be transmitted to the first input member, a locking arrangement configured to lock the output portion to a fixed member, an unlocking arrangement configured to unlock the output portion from the fixed member when the input portion rotates, and an arrangement configured to transmit rotation of the input portion to the output portion with a slight angular delay when the output portion is unlocked from the fixed member.

20. The driving force transmission mechanism of claim 2, wherein the reverse input blocking unit includes a wave generator configured such that the first driving force is applied to the wave generator, a circular spline fixed at a position radially outwardly of the wave generator, and a flex spline disposed between the wave generator and the circular spline, and coupled to the first input member such that rotation can be transmitted to the first input member, the reverse input blocking unit having a self-locking function.
